(19) United States
(12) Patent Application Publication
(10) Pub. No.: US 2021/0027210 A1
(43) Pub. Date: Jan. 28, 2021

(54) INFORMATION PROCESSING SYSTEM AND NON-TRANSITORY COMPUTER READABLE MEDIUM STORING PROGRAM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/741,772

(22) Filed: Jan. 14, 2020

(30) Foreign Application Priority Data
Jul. 26, 2019 (JP) 2019-137627

(51) Int. Cl. G06Q 10/02; G06Q 20/08

(52) U.S. Cl. CPC G06Q 10/02; G06Q 20/0855

(57) ABSTRACT

An information processing system includes an acquisition unit that acquires information on a reservation for use of a specific place in a specific time frame by plural users, and a charging unit that, if the plural users include a first user who did not come to the specific place before a predetermined time in the specific time frame, charges the first user for the specific place based on a fact that the first user did not come before the predetermined time.

### CROSS-REFERENCE TO RELATED APPLICATIONS

This application is based on and claims priority under 35 USC 119 from Japanese Patent Application No. 2019-137627 filed Jul. 26, 2019.

### BACKGROUND

### (i) Technical Field

The present disclosure relates to an information processing system and a non-transitory computer readable medium storing a program.

### (ii) Related Art

For example, Japanese Unexamined Patent Application Publication No. 2002-334253 discloses a time adaptive reservation charging method for charging reservations for use of facilities on a time basis. A user makes a reservation directed to a reservation server by using a user terminal to secure a facility from a time when the reservation is made to an expected start time of use that is specified when the reservation is made. The reservation server causes a facility management part to manage a period during which the user uses the facility within a range from the time when the reservation is made to the expected start time of use. Based on whether the facility is vacant or occupied and the usage of the facility by the user, the facility management part determines whether to charge the user for the facility per unit time within the range from the time when the reservation is made to the expected start time of use.

### SUMMARY

Aspects of non-limiting embodiments of the present disclosure relate to the following circumstances. A reservation may be made for use of a specific place in a specific time frame by a plurality of users. If any user did not come to the specific place in the specific time frame or arrived late at the specific place, the user may evade paying a fee for absence or late arrival.

It is desirable that a user who did not come to a specific place before a predetermined time in a specific time frame be charged for the specific place based on the fact that the user did not come before the predetermined time.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system comprising an acquisition unit that acquires information on a reservation for use of a specific place in a specific time frame by a plurality of users, and a charging unit that, if the plurality of users include a first user who did not come to the specific place before a predetermined time in the specific time frame, charges the first user for the specific place based on a fact that the first user did not come before the predetermined time.

### BRIEF DESCRIPTION OF THE DRAWINGS

An exemplary embodiment of the present disclosure will be described in detail based on the following figures, wherein:

FIG. 1 schematically illustrates an example of the overall configuration of an information processing system according to an exemplary embodiment;

FIG. 2 illustrates an example of the external structure of a booth type space;

FIG. 3 illustrates an example of the hardware configuration of each management server for use in the exemplary embodiment;

FIG. 4 illustrates an example of the hardware configuration of a user terminal according to the exemplary embodiment;

FIG. 5 illustrates an example of the functional configuration of a charging management server;

FIG. 6 is a flowchart illustrating an example of a procedure of processing to be executed by the charging management server;

FIG. 7 illustrates a specific example of the processing to be executed by the charging management server; and

FIG. 8 illustrates another example of the processing to be executed by the charging management server.

### DETAILED DESCRIPTION

An exemplary embodiment of the present disclosure is described below with reference to the drawings.

### <Overall Configuration of Information Processing System>

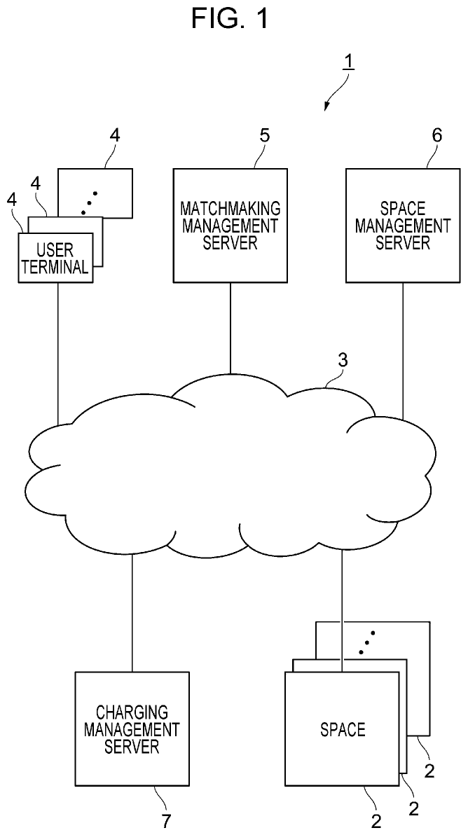

FIG. 1 schematically illustrates an example of the overall configuration of an information processing system 1 according to this exemplary embodiment. The information processing system 1 according to this exemplary embodiment includes various apparatuses and spaces 2 connected to a cloud network 3.

The spaces 2 include a booth, a room of an accommodation or the like, and a conference room of a company or the like. The spaces 2 may be movable places such as an automobile. Those spaces are examples of a space demarcated from surroundings with walls, partitions, or the like. The spaces 2 include a table and a seat in a restaurant or the like where a service is provided. Those spaces are examples of a space open to surroundings. Thus, the space 2 of this exemplary embodiment only needs to be a place available to a user and the type of the place is not limited.

The space 2 of this exemplary embodiment is assigned a name, a number, or the like for management. Reservations of the space 2 may be chargeable or free of charge.

If an electronic lock is attached to a door of the space 2, the space 2 is available under a condition that the user has an electronic key provided in advance. If the space 2 has no door, the space 2 is available, for example, by a method in which the user is authenticated by using an authentication code provided in advance or a manager of the space 2 verifies the name of the user who uses the space 2.

In this exemplary embodiment, a plurality of spaces 2 are provided as examples of a specific place.

As examples of the apparatuses connected to the cloud network 3, FIG. 1 illustrates user terminals 4 operated by users, a matchmaking management server 5 that manages matchmaking between users, a space management server 6 that manages the spaces 2, and a charging management server 7 that manages a process of charging users.

Matchmaking is a process of connecting users. For example, users are matched when one user invites persons who may share the users' specific purpose and another user accepts the invitation. Matchmaking services are provided, for example, to help someone find business partners, dating or marriage partners, or matches between someone who wants to teach and someone who wants to be taught. Matchmaking may be made not only between two users but also among three or more users.

In the case of FIG. 1, one server is prepared for each purpose or function. That is, one matchmaking management server 5, one space management server 6, and one charging management server 7 are prepared.

A plurality of servers may be prepared for one purpose or function or one server may be shared for a plurality of purposes or functions. For example, the matchmaking management server 5 or the space management server 6 may partially or entirely implement the functions of the charging management server 7.

The number of business entities that manage a certain space 2 may be one or plural. For example, different business entities may individually have responsibilities for management of reservations, management of authority to use the space 2, management of entry/exit and usage of rooms, management of charges for use on users, and management of members registered as users. Different business entities may manage the respective spaces 2.

As described above, the spaces 2 to be managed for reservations need not be the same type of space. For example, a subset of the spaces 2 may be booths and another subset of the spaces 2 may be a seat and a table in a restaurant or the like.

A plurality of business entities may offer management of one purpose or function in cooperation.

The user terminal 4 is an apparatus to be used by a user. In this exemplary embodiment, the user terminal 4 is assumed to be a smartphone to be carried by a user. The user terminal 4 may be a so-called wearable terminal, a notebook computer, or a game console.

The matchmaking management server 5 manages matchmaking between users. For example, the matchmaking management server 5 provides a website for matchmaking between users (hereinafter referred to as “matchmaking site”) and manages information input on the matchmaking site. Specifically, one user invites other users as partners by inputting his/her information on the matchmaking site to request matchmaking. Based on information exchanged on the matchmaking site, the matchmaking management server 5 arranges meeting of matched users. The meeting means that users directly meet each other.

The space management server 6 manages various types of information related to spaces 2.

For example, a user makes a reservation for use of a space 2 to meet a matched partner by causing his/her user terminal 4 to start an application or groupware for use in reservations for spaces 2. Thus, various types of information related to the reservation for the space 2 are stored in the space management server 6. The reservation for the space 2 may be made on the matchmaking site.

For example, various types of information related to use of a space 2 are acquired by apparatuses such as an image capturing apparatus 24, a motion sensor 25, and an information acquisition apparatus (not illustrated) described later. The acquired pieces of information are sequentially output to and stored in the space management server 6.

Various types of information related to a reservation for a space 2 are pieces of information on a reservation for use of a specific space 2 in a specific time frame by one or more users. Examples of the information include information on a user expected to use the space 2, information on the space 2, a start point of a time frame secured by the reservation, and an end point of the time frame secured by the reservation. Examples of the information on a user expected to use the space 2 include a name, a sex, an age, an organization (e.g., a company), an employee's ID, an account, a password, information assigned to manage the user, information on the face of the user, and a fingerprint and a vein pattern of the user. For example, the information on the face is an image of the face and is used as an example of biological information together with the fingerprint and the vein pattern. Examples of the information on the reserved space 2 include information on an address, a location, a management name, and a management number of the space 2.

Examples of various types of information related to use of a space 2 include information on a user who came to the space 2, information on the space 2, a start point of a time frame of use, and an end point of the time frame of use. Examples of the information on a user who came to the space 2 include information on the face of the user that is obtained by capturing an image of the user by the image capturing apparatus 24, information obtained from an ID card (e.g., a name, a sex, an age, an organization (e.g., a company), an employee's ID, an account, a password, information assigned to manage the user, and information on the face of the user), and a fingerprint and a vein pattern of the user that are acquired by the information acquisition apparatus. Examples of the information on the space 2 include information on an address, a location, a management name, and a management number of the space 2.

The space management server 6 may manage reservations for goods and services associated with a space 2. For example, the space management server 6 may manage items for rent, and goods and services sold and/or consumed at the space 2.

The charging management server 7 manages the process of charging users. For example, the charging management server 7 charges users based on various types of information related to reservations for spaces 2. If a reservation is made for use of a specific space 2 in a specific time frame by a plurality of users, any user may be absent by canceling the reservation immediately before the start time, or any other user may arrive late. In this case, a user who attended the reserved event in time may lose an opportunity of meeting or pay a fee for the space 2. Although details are described later, in this exemplary embodiment, a user who did not come to the specific space 2 before a predetermined time in the specific time frame is charged for the space 2 based on the fact that the user did not come before the predetermined time.

The predetermined time is a reference time to determine whether a user arrived late. Examples of the predetermined time include a start point of a specific time frame or a time point corresponding to 5 minutes past the start point. The predetermined time is hereinafter referred to as “late arrival determination time”. The late arrival determination time is set in advance depending on respective spaces 2 or a reservation system for the spaces 2, or is set depending on users who use the spaces 2.

### <Structure of Space>

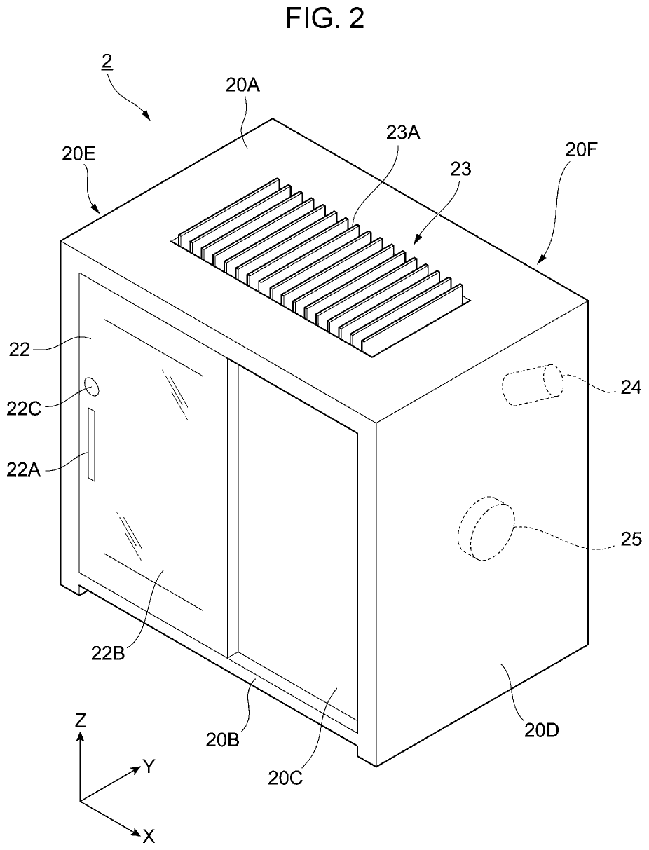

FIG. 2 illustrates an example of the external structure of a booth type space 2.

The booth type space 2 illustrated in FIG. 2 is arranged irrespective of indoors or outdoors. For example, the booth type space 2 is arranged in a station yard, an airport, an office building, a commercial facility such as a restaurant or a department store, a bank, a library, an art gallery, a museum, a public institution or facility, an accessway, or a park.

The booth type space 2 illustrated in FIG. 2 is a closed booth having a ceiling. The term “closed” does not mean “sealed” and the closed booth only needs to have a practical sound-proof property. Therefore, an opening or clearance such as an air vent or a small window may be provided in a portion of a frame that defines the space 2. The window may be openable and closable.

The frame of the space 2 illustrated in FIG. 2 includes a ceiling 20A, a floor 20B, a wall 20C having an openable and closable door 22, two walls 20D and 20E located on both sides of the wall 20C, and a wall 20F located opposite the door 22.

The ceiling 20A has a ventilating hole 23. A louver 23A capable of adjusting the opening area is attached to the ventilating hole 23. The louver 23A of FIG. 2 is fully open.

In this exemplary embodiment, the door 22 is assumed to be a sliding door movable along the wall 20C. In the case of FIG. 2, the door 22 is a single sliding door that slides in one direction. The door 22 may be a double sliding door to be opened or closed by moving two or more members in different directions, or a drawn door having two members slidable to right and left.

The door 22 is not limited to the sliding door. For example, the door 22 may be a single hinged door having one swingable member, or a double hinged door having one opening closed by two door members.

The door 22 may be a folding door to be opened by folding a pair of door members coupled by hinges. The folding door may be a folding door of a type in which door members are opened in one direction, or in which door members are opened in two directions.

As a special type of door, the door 22 may be a partition door or a retractable sliding door to be retracted into a wall when the door 22 is opened.

The door 22 may be opened inward or outward. The door 22 has a handle 22A to be gripped by a user when the door 22 is opened or closed.

A member 22B subjected to treatment in consideration of confidentiality and security is arranged at the center of the door 22. Examples of the member 22B include a transparent plate in which a metal plate having many arrays of holes (for example, a perforated metal) is attached on an inner side, a transparent plate in which a screen member is attached on an inner side with a clearance, a transparent plate having a film that makes it easy to view the inside from the front but difficult to view the inside in a slanting direction, and a transparent plate subjected to treatment for reducing internal visibility.

For example, glass or an acrylic resin is used for the transparent plate. A characteristic related to the transparency of the film bonded for confidentiality and security is determined based on a relationship between the position of the door 22 and the working position of the user. If the user works on a far side behind the front of the door 22, it is appropriate to use a film that makes it difficult to view the inside from the front but easy to view the inside in a slanting direction.

The film may be a liquid crystal film whose transparent state and opaque state are switchable electrically, or a polarizing film whose transmittance is controllable electrically.

Examples of the treatment for reducing visibility include finely scoring the surface of the member so that light is scattered.

The treatment may be performed on a portion of the member 22B. For example, the structure may be provided such that the member 22B is transparent near the floor and the ceiling and the visibility is reduced through the treatment in a range in which a monitor may be viewed during work.

By arranging the member 22B, the presence or absence of the user may be checked from the outside while hiding a screen of the monitor from the outside.

An electronic lock 22C unlockable with an electronic key is attached to the door 22.

The treatment in consideration of confidentiality and security may be performed on a member other than the door 22. For example, the treatment may be performed on at least a portion of the wall 20D, 20E, or 20F.

The number of users of the space 2 is roughly determined depending on the volume of the space 2. The space 2 illustrated in FIG. 2 is assumed to be a private room that is basically used by a few users (e.g., one to three users). The space 2 according to this exemplary embodiment may be a large room capable of accommodating many users. The large room may be formed as a single room but may be formed by removing one or both of the walls 20D and 20E of the space 2 and coupling a plurality of spaces 2.

The shape and structure of the frame that defines the space 2 and the provided equipment and performance thereof are arbitrary. For example, the ceiling 20A may be omitted.

In this exemplary embodiment, a desk and a chair (not illustrated) are arranged in the frame. Furnished equipment and devices or reserved equipment and devices are arranged on the desk.

The image capturing apparatus 24 such as a camera that captures an image of the inside of the frame and the motion sensor 25 that detects a user in the frame are provided in the frame. The information acquisition apparatus (not illustrated) that acquires information on each user of the space 2 may be provided on an outer side of the frame. Examples of the information acquisition apparatus include a reader that reads an ID card held by a user, and a reader that reads a fingerprint or a vein pattern of a user.

### <Hardware Configurations of Apparatuses>

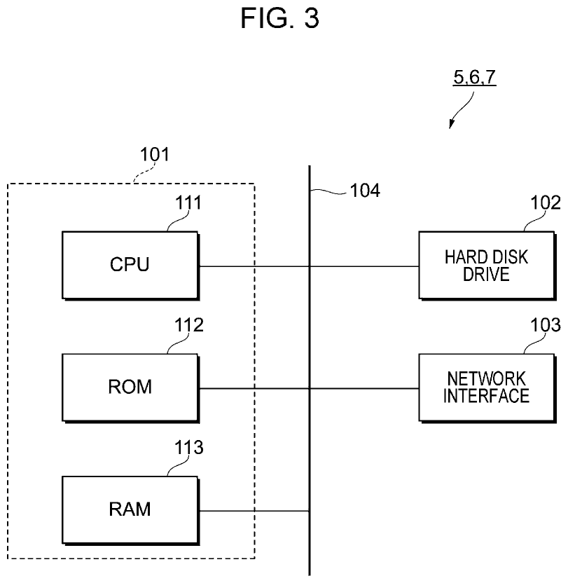

FIG. 3 illustrates an example of the hardware configuration of each management server for use in the exemplary embodiment. The management servers of this exemplary embodiment are the matchmaking management server 5 (see FIG. 1), the space management server 6 (see FIG. 1), and the charging management server 7 (see FIG. 1).

The management server includes a control unit 101 that controls an overall operation of the apparatus, a hard disk drive 102 that stores management data and the like, and a network interface 103 that achieves communication via a local area network (LAN) cable or the like.

The control unit 101 includes a central processing unit (CPU) 111, a read only memory (ROM) 112 that stores basic software, a basic input/output system (BIOS), and the like, and a random access memory (RAM) 113 to be used as a working area. The CPU 111 may be a multi-core CPU. The ROM 112 may be a rewritable non-volatile semiconductor memory. The control unit 101 is a so-called computer.

The hard disk drive 102 is an apparatus that reads and writes data on a non-volatile storage medium obtained by applying a magnetic substance to the surface of a disc-shaped substrate. The non-volatile storage medium may be a semiconductor memory or a magnetic tape.

As necessary, the management server includes an input device such as a keyboard and a mouse, and a display device such as a liquid crystal display.

The control unit 101, the hard disk drive 102, and the network interface 103 are connected through a bus 104 and signal lines (not illustrated).

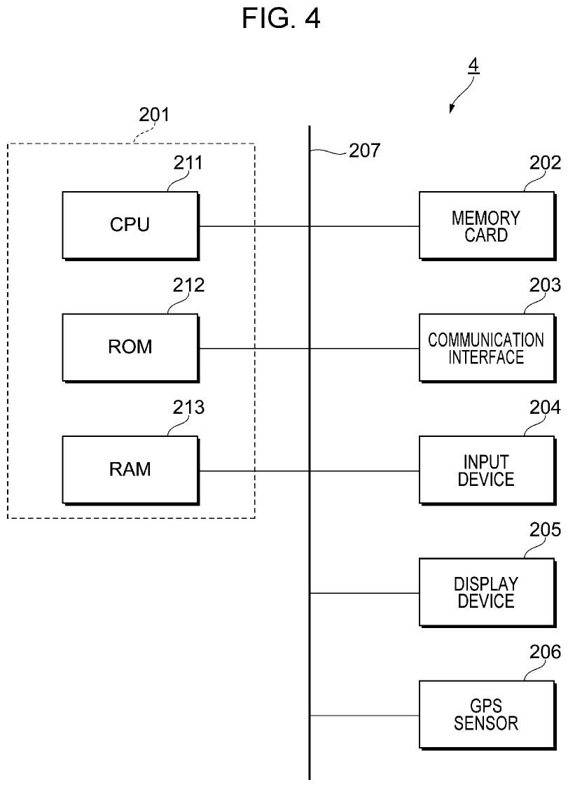

FIG. 4 illustrates an example of the hardware configuration of the user terminal 4 according to this exemplary embodiment. In FIG. 4, the user terminal 4 is assumed to be a smartphone.

The user terminal 4 includes a control unit 201 that controls an overall operation of the apparatus, a memory card 202 that stores various types of data, various types of communication interface 203 conforming to wireless communication standards, an input device 204 such as a touch sensor, a display device 205 such as a liquid crystal display or an organic electroluminescence (EL) display, a Global Positioning System (GPS) sensor 206, and a bus 207 that connects the respective parts.

The control unit 201 includes a CPU 211, a ROM 212 that stores firmware, a BIOS, and the like, and a RAM 213 to be used as a working area. The CPU 211 may be a multi-core CPU. The ROM 212 may be a rewritable non-volatile semiconductor memory.

Examples of the communication interface 203 include interfaces for connection to the matchmaking management server 5, the space management server 6, and the charging management server 7, and an interface for connection to a wireless LAN.

The GPS sensor 206 measures the position of the user terminal 4 by receiving an electric wave from a GPS satellite. Information on a latitude, a longitude, and an altitude output from the GPS sensor 206 indicates a current position of the user terminal 4. The GPS sensor 206 may be compatible with an indoor positioning system.

### <Functional Configuration of Charging Management Server>

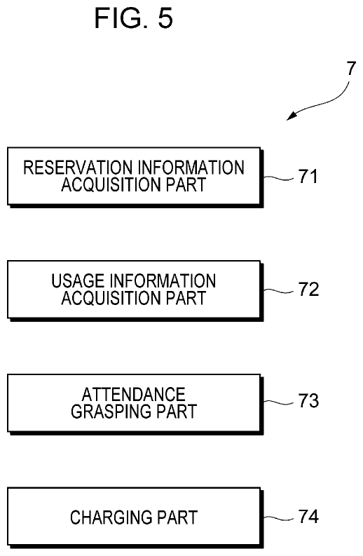

FIG. 5 illustrates an example of the functional configuration of the charging management server 7. The charging management server 7 includes a reservation information acquisition part 71, a usage information acquisition part 72, an attendance grasping part 73, and a charging part 74.

The reservation information acquisition part 71, which is an example of an acquisition unit, acquires, from the space management server 6, various types of information related to reserved events in spaces 2 that have already finished but have not yet undergone a process of charging users.

The usage information acquisition part 72 acquires various types of information related to use of the spaces 2 from the space management server 6.

The attendance grasping part 73 grasps attendances of the users at the reserved events handled by the reservation information acquisition part 71 based on the information acquired by the reservation information acquisition part 71 and the information acquired by the usage information acquisition part 72.

For example, the attendance grasping part 73 grasps that a reservation was made for use of a specific space 2 in a specific time frame by a plurality of users based on the information acquired by the reservation information acquisition part 71. The attendance grasping part 73 grasps whether each user came to the specific space 2 and, if the user came, grasps a time when the user came to the space 2 based on the information acquired by the usage information acquisition part 72. If the plurality of users include a user who did not come to the specific space 2 before a late arrival determination time in the specific time frame, determination is made that the user was absent or arrived late.

The charging part 74, which is an example of a charging unit, charges the users based on the attendance information grasped by the attendance grasping part 73.

For example, if a reservation was made for use of a specific space 2 in a specific time frame by a user, the charging part 74 charges the user for the space 2. Although details are described later, if a reservation was made for use of a specific space 2 in a specific time frame by a plurality of users but any user did not come to the space 2 before a late arrival determination time in the time frame, the charging part 74 charges the user for the space 2 based on the fact that the user did not come before the late arrival determination time.

If a reservation was made for use of a specific space 2 in a specific time frame by a plurality of users, the charging part 74 charges the users based on at least one of information on whether the users came to the space 2 in the time frame or information on times when the users came to the space 2.

If a reservation was made for use of a specific space 2 in a specific time frame by one user, the user may be charged irrespective of whether the user came to the space 2. In this case, the charging process is performed by using different information depending on whether the number of users expected to use a space 2 is one or plural.

For example, fees are charged on preregistered credit cards but the charging method is not limited. For example, an invoice may be sent to an address of a user to be charged.

The functional parts of the charging management server 7 are implemented in cooperation between a software resource and a hardware resource. Specifically, if the charging management server 7 is implemented by the hardware configuration illustrated in FIG. 3, the functional parts such as the reservation information acquisition part 71, the usage information acquisition part 72, the attendance grasping part 73, and the charging part 74 are implemented such that a program stored in the hard disk drive 102 is read on the RAM 113 and executed by the CPU 111.

### <Processing to be Executed by Charging Management Server>

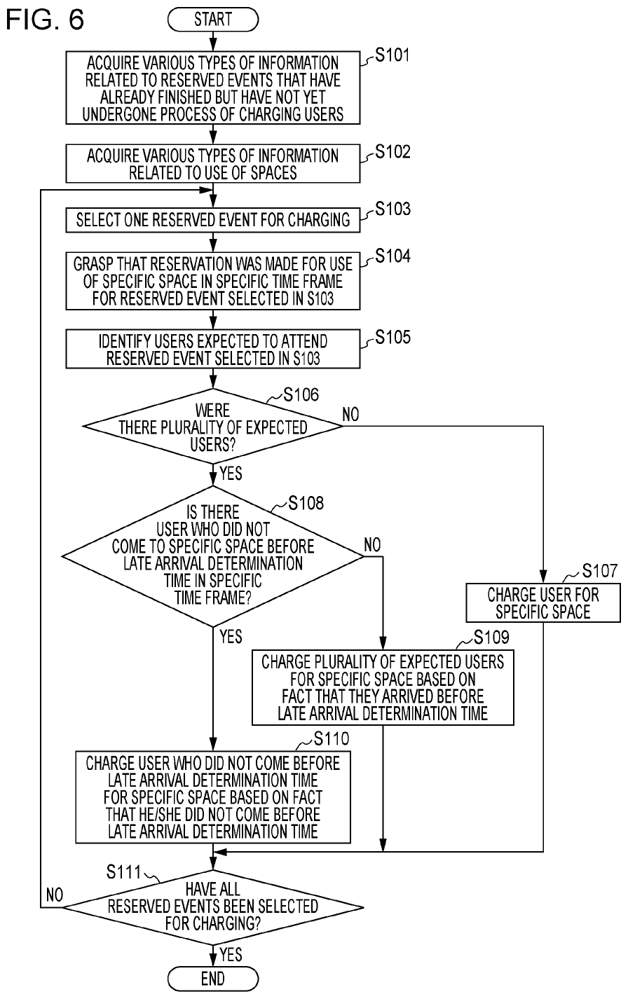

FIG. 6 is a flowchart illustrating an example of a procedure of processing to be executed by the charging management server 7. The processing illustrated in FIG. 6 is executed at every predetermined timing (e.g., every 1 minute).

Each processing step is hereinafter represented by a symbol “S”.

First, the reservation information acquisition part 71 acquires, from the space management server 6, various types of information related to reserved events in spaces 2 that have already finished but have not yet undergone a process of charging users (S101). Next, the usage information acquisition part 72 acquires various types of information related to use of the spaces 2 from the space management server 6 (S102).

Next, the attendance grasping part 73 selects one reserved event for charging based on the information acquired by the reservation information acquisition part 71 (S103). Next, the attendance grasping part 73 grasps that a reservation was made for use of a specific space 2 in a specific time frame for the reserved event selected in S103 based on the information acquired by the reservation information acquisition part 71 (S104). The attendance grasping part 73 identifies users expected to attend the reserved event selected in S103 (S105). Next, the attendance grasping part 73 determines whether a plurality of (i.e., two or more) users were expected to attend the reserved event (S106).

If the result of determination in S106 is negative (NO), that is, if one user was expected to attend the reserved event, the charging part 74 charges the user for the specific space 2 (S107). The expected user is charged for the specific space 2 irrespective of whether the user came to the space 2. Then, the processing proceeds to S111.

If the result of determination in S106 is positive (YES), that is, if a plurality of users were expected to attend the reserved event, the attendance grasping part 73 determines whether the plurality of expected users include a user who did not come to the specific space 2 before a late arrival determination time in the specific time frame (S108).

In S108, the attendance grasping part 73 identifies a user who came to the reserved space 2 based on the information acquired by the usage information acquisition part 72. Specifically, the user who came to the space 2 is identified based on information on the face of the user that is obtained by capturing an image of the user by the image capturing apparatus 24 or information on the name and account of the user that is obtained from an ID card. Users who came to the space 2 may be identified by communicating with each other on their user terminals 4 to approve that they came to the space 2. The attendance grasping part 73 grasps whether each expected user came to the space 2 by comparing the user identified in this manner with the users identified in S105 and, if the user came, grasps a time when the user came to the space 2.

If the result of determination in S108 is negative (NO), the charging part 74 charges the plurality of expected users for the specific space 2 based on the fact that they arrived before the late arrival determination time (S109). Then, the processing proceeds to S111.

If the result of determination in S108 is positive (YES), the charging part 74 charges the user who did not come before the late arrival determination time out of the plurality of expected users for the specific space 2 based on the fact that the user did not come before the late arrival determination time (S110). Users who arrived before the late arrival determination time are charged based on the fact that they arrived before the late arrival determination time. Then, the processing proceeds to S111.

After S107, S109, or S110, the attendance grasping part 73 determines whether all the reserved events have been selected for charging based on the information acquired by the reservation information acquisition part 71 (S111). If the result of determination in S111 is positive (YES), the processing flow is terminated. If the result of determination in S111 is negative (NO), the processing proceeds to S103 to continue the charging process.

### Specific Example of Processing to be Executed by Charging Management Server

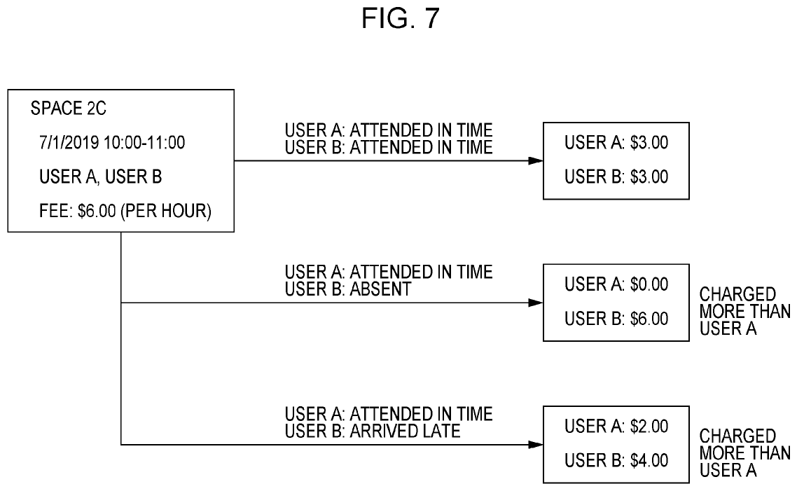

Next, a specific example of the processing to be executed by the charging management server 7 is described. FIG. 7 illustrates the specific example of the processing to be executed by the charging management server 7.

In this example, a user A and a user B were matched on a matchmaking site. The user A and the user B arranged meeting and made a reservation for a space 2C. As illustrated in FIG. 7, a reservation was made for use of the space 2C during 10:00-11:00 on 7/1/2019 by the user A and the user B. The usage fee of the space 2C was $6.00 per hour. The late arrival determination time was set to 10:05 on 7/1/2019.

For example, if both the user A and the user B arrived before 10:05 on 7/1/2019, they attended the reserved event in time. In this case, for example, the charging part 74 evenly charges the user A and the user B for use of the space 2C. That is, the charging part 74 charges the user A $3.00 and the user B $3.00.

For example, if the user A arrived in time before 10:05 on 7/1/2019 but the user B did not come during 10:00-11:00 by canceling the reservation immediately before the start time of 10:00, the user B is regarded as having been absent. In this case, the charging part 74 charges the user B for the space 2C based on the fact that the user B did not come before 10:05. In other words, the user B is charged for absence. Specifically, the charging part 74 charges the user B $6.00 for the space 2C, including the fee of the user A. The charging part 74 does not charge the user A.

The user B did not come to the space 2C but is charged $6.00 for the space 2C. The user A came to the space 2C but is charged $0.00 for the space 2C. That is, the user A is not charged for the space 2C. In this example, the absent user B is charged for the space 2C more than the user A who arrived in time.

In the normal case (i.e., both the user A and the user B attended the reserved event in time), the user A and the user B are charged $3.00, respectively. If the user B was absent, the user A is charged $0.00. In this example, if the user B was absent, the user A is charged less than in the normal case. If the user B was absent, the user B is charged $6.00. In this example, if the user B was absent, the user B is charged more than in the normal case.

In this example, the absent user B is charged $6.00 including the fee of the user A who attended the reserved event and the user A is not charged. The fees are not limited to those in this example.

For example, if a user who attended the reserved event and a user who was absent from the reserved event are charged at a ratio of 1:5, the user A is charged $1.00 and the user B is charged $5.00.

For example, a user who attended the reserved event and a user who was absent from the reserved event may be charged evenly and the absent user may further be charged for a penalty. For example, the user A is charged $3.00 as in the normal case and the user B is charged a total of $4.00 including a penalty of $1.00 added to $3.00 in the normal case.

A user who was absent from the reserved event may pay a traveling expense of a user who attended the reserved event. In this case, the user who was absent from the reserved event is charged for the traveling expense of the user who attended the reserved event.

For example, if the user A arrived in time before 10:05 on 7/1/2019 but the user B came at 10:20 on 7/1/2019, the user B arrived after 10:05 and is therefore regarded as having arrived late. In this case, the charging part 74 charges the user B for the space 2C based on the fact that the user B did not come before 10:05. In other words, the user B is charged for late arrival. Specifically, the charging part 74 charges the user B twice as much as the user A for the space 2C. That is, the charging part 74 charges the user A $2.00 and the user B $4.00.

The user B arrived late at the space 2C but is charged $4.00 for the space 2C. The user A arrived in time at the space 2C but is charged $2.00 for the space 2C. In this example, the user B who arrived late is charged for the space 2C more than the user A who arrived in time.

In the normal case (i.e., both the user A and the user B attended the reserved event in time), the user A and the user B are charged $3.00, respectively. If the user B arrived late, the user A is charged $2.00. In this example, if the user B arrived late, the user A is charged less than in the normal case. If the user B arrived late, the user B is charged $4.00. In this example, if the user B arrived late, the user B is charged more than in the normal case.

In this example, the user B who arrived late is charged twice as much as the user A but the fees are not limited to those in this example.

For example, if a user who arrived in time and a user who arrived late are charged at a ratio of 1:5, the user A is charged $1.00 and the user B is charged $5.00.

Similarly to the case where a user was absent, a user who arrived late may additionally be charged for a penalty or may be charged for a traveling expense of a user who arrived in time.

Users may be charged depending on a time when a user arrived late at the space 2, in other words, depending on the length of time until the user arrived late.

For example, the user B came at 10:20 and therefore arrived 20 minutes late from the start time. As a result, the user B stayed in the space 2C for 40 minutes from 10:20 to the end time of 11:00. The user A stayed in the space 2C for 60 minutes from 10:00 to 11:00. The user A and the user B are charged at a ratio of 40:60, that is, 2:3. The user A is charged $2.40 and the user B is charged $3.60.

For example, if the user B came at 10:20, the user B may be charged for the 20-minute usage and the user A and the user B may be charged evenly for the remaining 40-minute usage. For example, the fee for the first 20-minute usage is $2.00 and the fee for the remaining 40-minute usage is $4.00. The user B is entirely charged $2.00 for the first 20-minute usage and the user A and the user B are evenly charged $2.00 to pay $4.00 for the remaining 40-minute usage. For example, if the user B came at 10:20, the user A and the user B may be charged evenly for the first 20-minute usage and the user B may be charged for the remaining 40-minute usage.

For example, a fee may be set for late arrival per minute. For example, if $0.30 is set for late arrival per minute, the user B who arrived 15 minutes late is charged $4.50. Since the usage fee of the space 2C is $6.00, the user A and the user B are evenly charged $1.50 as the remainder. As a result, the user A is charged $0.75 and the user B is charged $5.25.

As described above, if a reservation was made for use of a specific space 2 in a specific time frame by a plurality of users but any user did not come to the space 2 before a late arrival determination time in the time frame, the user is charged for the space 2 based on the fact that the user did not come before the late arrival determination time.

In this example, the user B who arrived late or was absent is charged more than the user A but the charging method is not limited to that in this example. For example, the user B and the user A may be charged equally or the user A may be charged more.

In this example, if the user B arrived late or was absent, the user A is charged less than in the normal case (i.e., both the user A and the user B attended the reserved event in time) but the charging method is not limited to that in this example. For example, if the user B arrived late or was absent, the user A may be charged as in the normal case or more than in the normal case.

How the user who attended the reserved event in time and the user who arrived late at or was absent from the reserved event are charged may be determined in advance depending on respective spaces 2 or the reservation system for the spaces 2, or may be determined in advance among the users. The determination may be made later among the users. If the determination is made later among the users, negotiation is made, for example, such that the user who attended the reserved event in time shows the ratio of fees and then the user who arrived late at or was absent from the reserved event decides whether to accept the ratio of fees. Even if any user arrived late or was absent, the user may be charged, through determination made in advance or later, similarly to the case where there is no user who arrived late or was absent.

In this example, the usage fee of the space 2 is charged as the fee for the space 2 but some spaces 2 may be available free of charge. If a space 2 is available free of charge, a penalty fee is charged as the fee for the space 2.

### Other Example of Processing to be Executed by Charging Management Server

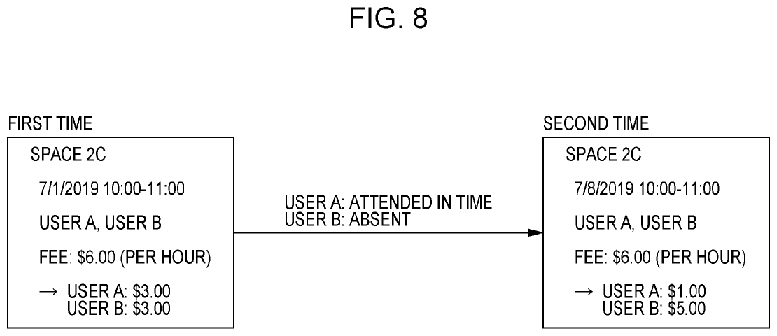

Next, another example of the processing to be executed by the charging management server 7 is described. FIG. 8 illustrates the other example of the processing to be executed by the charging management server 7.

In the example illustrated in FIG. 8, if a reservation was made for use of a specific space 2 in a specific time frame by a plurality of users and a first user came to the space 2 before a late arrival determination time in the time frame but a second user did not come before the late arrival determination time, the users are charged for a next reserved event based on this situation.

In this example, a reservation was made for use of the space 2C during 10:00-11:00 on 7/1/2019 by the user A and the user B similarly to the example illustrated in FIG. 7. The usage fee of the space 2C was $6.00 per hour. The late arrival determination time was set to 10:05 on 7/1/2019.

For example, the user A arrived in time before 10:05 on 7/1/2019 but the user B was absent by canceling the reservation immediately before the start time of 10:00. A reservation was made again for use of the space 2C by the user A and the user B on a different day, that is, during 10:00-11:00 on 7/82019 and both the user A and the user B arrived in time at the space 2C.

In this case, for example, the charging part 74 evenly charges the user A and the user B for use of the space 2C in the first reservation (i.e., the reservation for 10:00-11:00 on 7/1/2019). That is, the charging part 74 charges the user A $3.00 and the user B $3.00. In the second reservation (i.e., the reservation for 10:00-11:00 on 7/8/2019), the charging part 74 surcharges the user B for use of the space 2C based on the fact that the user B was absent in the first reservation. Since the usage fee of the space 2C is $6.00, the user A and the user B would be charged $3.00, respectively, if evenly charged. In this case, the user B is charged $5.00 by adding $2.00. The user A is charged $1.00 by reducing $2.00.

The total of the fee for the first reservation and the fee for the second reservation is $4.00 for the user A and $8.00 for the user B. That is, the user B who was absent in the first reservation is charged more than the user A.

Thus, the users are charged for the second reservation based on the situation of the first reservation.

In this example, the user A and the user B are charged evenly for use of the space 2C in the first reservation but the charging method is not limited to that in this example. In the first reservation, the absent user B may be charged more than the user A. For example, the user A may be charged $0.00 and the user B may be charged $6.00 for the first reservation and the user A may be charged $0.00 and the user B may be charged $6.00 for the second reservation. In the first reservation, the user A may be charged more than the absent user B.

This example is directed to the case where the user B was absent. A similar charging procedure may be employed in the case where the user B arrived late.

In this example, the first and second reservations were made for the same space 2C. A similar charging procedure may be employed in a case where the first and second reservations were made for different spaces 2.

In this example, the second reservation was made after the event created by the first reservation had finished but the timing to make the second reservation is not limited. For example, a similar charging procedure may be employed in a case where the second reservation was made before the start time of the event created by the first reservation.

How the fees for the second reservation are charged may be determined in advance depending on respective spaces 2 or the reservation system for the spaces 2, or may be determined among the users. The determination may be made among the users at any timing, that is, before or after the second reservation is made.

In the second reservation, users may decide where to meet based on the situation of the first reservation. For example, in the second reservation, a user who attended the first reserved event in time may be vested with authority to decide the location of a space 2 and make a reservation for a space 2 near the user's residence.

In this example, the user B arrived in time in the second reservation. If the user B arrived late or was absent in the second reservation, the users are charged for a third reservation based on this situation. For example, if the usage fee of the space 2C secured by the third reservation is $6.00, the user A is charged $1.00 and the user B is charged $5.00 for the third reservation.

### Other Examples

Next, other examples of this exemplary embodiment are described.

(Processing to be Executed when Notification of Late Arrival or Absence is Given in Advance)

In this exemplary embodiment, if a user gave, before a specific time, a notification that the user would not come to the space 2 before a late arrival determination time, the user need not be charged based on the fact that the user did not come before the late arrival determination time.

The specific time is a reference time to determine whether to charge a user. For example, the specific time is set in advance depending on respective spaces 2 or the reservation system for the spaces 2, or is set depending on users who use the spaces 2. Specifically, the specific time is a time point corresponding to 1 hour before a start point of a time frame secured by a reservation.

For example, the user A and the user B arranged meeting and made a reservation for the space 2C. The user A arrived in time but the user B was absent through cancellation. The user B notified, before a specific time, the user A or a manager of the space 2C that the user B would not come to the space 2C before a late arrival determination time. In this case, the user B need not be charged based on the fact that the user B did not come before the late arrival determination time. If the usage fee of the space 2C is $6.00, for example, the user A and the user B are evenly charged $3.00.

In this example, the user B was absent but the user B who arrived late need not similarly be charged based on the fact that the user B did not come before the late arrival determination time.

### (Processing of Charging Plurality of Users Based on Relationship Between Users)

In this exemplary embodiment, a plurality of users who use a space 2 may be charged for the space 2 based on a relationship between the users.

For example, if a reservation was made for use of the space 2C by the user A and the user B, the user A and the user B may be charged based on the number of times they met previously. For example, the usage fee of the space 2C was $6.00. If the user B was absent by canceling the reservation immediately before the start time and had not ever met the user A, the user A is charged $0.00 and the user B is charged $6.00. If the user B had ever met the user A once, the user A is charged $1.00 and the user B is charged $5.00.

For example, if the user B was absent by canceling the reservation immediately before the start time and if the user A was a foreign language teacher and the user B was his/her student, the user A is charged $1.00 and the user B is charged $5.00 based on the relationship of the teacher and the student for foreign language acquisition. For example, if the user A and the user B meet for the purpose of seeking marriage partners, the user A is charged $0.00 and the user B is charged $6.00 based on the relationship of candidates of marriage partners.

Thus, the fees are adjusted based on the relationship between the plurality of users.

### (Processing of Charging Users Based on Purpose of Use of Space)

In this exemplary embodiment, a plurality of users may be charged for the space 2 based on a purpose of use of the space 2.

For example, a reservation was made for use of the space 2C by the user A and the user B but the user B was absent by canceling the reservation immediately before the start time. The usage fee of the space 2C was $6.00. If the user A is a foreign language teacher and the user B is his/her student, the user A is charged $1.00 and the user B is charged $5.00 for the purpose of foreign language acquisition. For example, if the user A and the user B use the space 2C for the purpose of seeking marriage partners, the user A is charged $0.00 and the user B is charged $6.00 for this purpose.

Thus, the fees are adjusted based on the purpose of use of the space.

### (Processing of Charging Users for Service)

In the examples described above, users are charged for a space 2 secured by a reservation. If a fee-based service is provided in a space 2, a charging procedure similar to those in the examples described above may be employed for a service fee. Examples of the fee for a service provided in a space 2 include a fee for a foreign language lesson in a case where the space 2 is used for the purpose of foreign language acquisition, and a meal charge in a case where the space 2 is a restaurant.

For example, if the user A is a foreign language teacher, the user B is his/her student, and the space 2C is used for the purpose of foreign language acquisition, the user A arrived in time at the space 2C but the user B arrived late or was absent. In this case, the user B is charged for a foreign language lesson provided in the space 2C based on the fact that the user B did not come before a late arrival determination time. Specifically, if the fee for the foreign language lesson is $10.00, the user B is charged $10.00 for the lesson. The user B may be charged for use of the space 2C in addition to the foreign language lesson. For example, if the usage fee of the space 2C is $6.00, the user B is also charged $6.00 for use of the space 2C. Thus, the user B is charged a total of $16.00 for the lesson and for use of the space 2C.

Users may be charged depending on a service type such as a foreign language lesson or a meal. For example, a user who arrived late or was absent may be charged for a service provided in a space 2 at a variable ratio or with a variable upper limit depending on the service type.

Depending on services, fees may be determined in advance or may be determined at sites. For example, if the space 2 is a restaurant, a meal charge is determined based on orders given on a day when the space 2 is used. If a service fee is determined at a site, users may be charged by an amount determined in advance or may be charged based on a situation of the day when the space is used. If the users are charged based on a situation of the day when the space is used, for example, a user who arrived late or was absent may be charged at a predetermined ratio of the fee determined on that day or may be charged by a predetermined upper limit amount. The user may be charged based on the length of time until late arrival.

### (Others)

If any user out of a plurality of users is absent through cancellation, the other users may know the cancellation and quit going to the space 2. Therefore, the users may be charged depending on whether the other users go to the space 2.

For example, if a reservation was made for use of the space 2C by the user A and the user B, the user B was absent by canceling the reservation immediately before the start time. The usage fee of the space 2C was $6.00. If the user A went to the space 2C, the user A is charged $0.00 and the user B is charged $6.00. If the user A did not go to the space 2C, the user A and the user B are evenly charged $3.00.

In the examples described above, users who use a space 2 are matched on the matchmaking site provided by the matchmaking management server 5 but the matchmaking method is not limited. For example, a plurality of users may be matched by communicating with each other on their user terminals 4 without intervention of the matchmaking management server 5. Specifically, the user terminal 4 identifies other user terminals 4 in its surroundings by using close-proximity wireless communication such as Bluetooth (registered trademark), wide-area wireless communication such as low power wide area (LPWA), or positional information measured by the GPS sensor 206. The user terminal 4 communicates with the other identified user terminals 4 to match users.

In this exemplary embodiment, the users who use a space 2 are not limited to matched users. For example, the charging method according to this exemplary embodiment may be applied to a case where a reservation is made for use of a space 2 by a plurality of users belonging to the same workplace or by a plurality of friends.

The program that implements the exemplary embodiment of the present disclosure may be provided by a communication unit and may also be provided by being stored in a recording medium such as a CD-ROM.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system, comprising:
an acquisition unit that acquires information on a reservation for use of a specific place in a specific time frame by a plurality of users; and
a charging unit that, if the plurality of users include a first user who did not come to the specific place before a predetermined time in the specific time frame, charges the first user for the specific place based on a fact that the first user did not come before the predetermined time.

2. The information processing system according to claim 1, wherein, if the plurality of users include the first user and a second user who came to the specific place before the predetermined time, the charging unit charges the first user more than the second user for the specific place.

3. The information processing system according to claim 1, wherein, if the plurality of users include the first user, the charging unit charges, for the specific place, a second user who came to the specific place before the predetermined time less than in a case where the plurality of users do not include the first user.

4. The information processing system according to claim 1, wherein, if the first user came to the specific place at a time after the predetermined time in the specific time frame, the charging unit charges the first user based on the time when the first user came to the specific place.

5. The information processing system according to claim 4, wherein the charging unit charges, for the specific place, a second user who came to the specific place before the predetermined time based on the time when the first user came to the specific place.

6. The information processing system according to claim 1, wherein, if the plurality of users include the first user and a second user who came to the specific place before the predetermined time and if a reservation is made for next meeting of the first user and the second user, the charging unit charges the first user for a next place secured by the reservation based on the fact that the first user did not come before the predetermined time.

7. The information processing system according to claim 6, wherein the charging unit charges the first user more than the second user in terms of a total of a fee for the specific place and a fee for the next place secured by the reservation.

8. The information processing system according to claim 1, wherein, if the first user gave, before a specific time, a notification that the first user was not going to the specific place before the predetermined time, the charging unit does not charge the first user based on the fact that the first user did not come before the predetermined time.

9. The information processing system according to claim 1, wherein, if a fee-based service is provided in the specific place, the charging unit further charges the first user for the service based on the fact that the first user did not come before the predetermined time.

10. The information processing system according to claim 9, wherein the charging unit charges the first user for the service depending on a type of the service.

11. The information processing system according to claim 1, wherein the charging unit charges the first user for the specific place based on a relationship between the plurality of users.

12. The information processing system according to claim 1, wherein the charging unit charges the first user for the specific place based on a purpose of use of the specific place by the plurality of users.

13. An information processing system, comprising:
an acquisition unit that acquires information on a reservation for use of a specific place in a specific time frame by a user; and
a charging unit that charges the user for the specific place based on the information acquired from the acquisition unit,
wherein, if the information indicates that a reservation is made for use of the specific place by a plurality of users, the charging unit charges the plurality of users by using at least one of information on whether the plurality of users came to the specific place in the specific time frame or information on times when the plurality of users came to the specific place.

14. A non-transitory computer readable medium storing a program causing a computer to execute a process comprising:
acquiring information on a reservation for use of a specific place in a specific time frame by a plurality of users; and
charging, if the plurality of users include a first user who did not come to the specific place before a predetermined time in the specific time frame, the first user for the specific place based on a fact that the first user did not come before the predetermined time.
